(19) United States
(12) Patent Application Publication
(10) Pub. No.: US 2025/0180849 A1
(43) Pub. Date: Jun. 5, 2025

(54) METHOD AND SYSTEM FOR CONTROLLING THE TENSION ON A BUFFER TUBE BY A COMPRESSION CATERPILLAR ON A BUFFERING LINE

(71) Applicant: CORNING RESEARCH & DEVELOPMENT CORPORATION, Corning, NY (US)

(72) Inventors: Shelby Lynn Anderson, Lincoln, NE (US); Edward A. Bolick, Pfafftown, NC (US); JoAnn Elizabeth Causey, Thomasville, NC (US); Randy Curtis Smith, Lincolnton, NC (US); Brittany L Wilson, Wendell, NC (US)

(21) Appl. No.: 19/044,853

(22) Filed: Feb. 4, 2025

Related U.S. Application Data
(63) Continuation of application No. PCT/US2023/029480, filed on Aug. 4, 2023.
(60) Provisional application No. 63/396,719, filed on Aug. 10, 2022.

(51) Int. Cl. G02B 6/44; B29D 11/00

(52) U.S. Cl. CPC G02B 6/4486; B29D 11/00875; G02B 6/4484

(57) ABSTRACT

Embodiments of the disclosure relate to a method of controlling tension on a buffer tube produced on a buffer tube processing line. In the method, the buffer tube is directed through a compression caterpillar. A speed of and a gap between drive belts of the compression caterpillar are set to achieve a desired tension on the buffer tube. Tension on the buffer tube is measured as the buffer tube passes between the drive belts. It is determined whether the measured tension on the buffer tube is within an acceptable range, and the gap between the drive belts is decreased in increments while the buffer tube passes between the drive belts until the tension is within the acceptable range.

This application is a continuation of International Application No. PCT/US2023/029480, filed Aug. 4, 2023, which claims the benefit of priority of U.S. Provisional Application Ser. No. 63/396,719 filed on Aug. 10, 2022, the content of which is relied upon and incorporated herein by reference in its entirety.

### BACKGROUND

The disclosure relates generally to producing a subunit of an optical fiber cable and, in particular, to a method and a system for controlling excess fiber length relative to the buffer tube length of a subunit. In optical fiber cables, subunits may be used to provide organization of the optical fibers. For example, each subunit may include a plurality of optical fibers arranged within a buffer tube. The optical fibers may have an ink coating for identification, and the buffer tubes may also have different colors to distinguish between subunits. In this way, specific optical fibers can be identified by reference to the color of the buffer tube and the color of the optical fiber within the buffer tube. Buffer tubes are typically extruded around the optical fibers to form the subunit. During extrusion, the buffer tube is a molten polymer material, and such polymer materials may undergo significant contraction during cooling. Because the optical fibers have a glass core and cladding, which have a much lower coefficient of thermal expansion, the optical fibers do not experience much, if any, contraction at the buffer tube extrusion temperatures. Thus, if the contraction of the buffer tube relative to the optical fibers is not accounted for, the subunit will have too much excess fiber length, which can lead to attenuation of the signal carried in the optical fibers during operation.

### SUMMARY

According to an aspect, embodiments of the disclosure relate to a method of controlling tension on a buffer tube produced on a buffer tube processing line. In the method, the buffer tube is directed through a compression caterpillar. A speed of and a gap between drive belts of the compression caterpillar are set to achieve a desired tension on the buffer tube. Tension on the buffer tube is measured as the buffer tube passes between the drive belts. It is determined whether the measured tension on the buffer tube is within an acceptable range, and the gap between the drive belts is decreased in increments while the buffer tube passes between the drive belts until the tension is within the acceptable range.

According to another aspect, embodiments of the disclosure relate to a system for controlling tension on a buffer tube produced on a processing line. The system includes a compression caterpillar having a first drive belt and a second drive belt with the first drive belt and the second drive belt having a gap therebetween. The system also includes a controller configured to control the gap between the first drive belt and the second drive belt. The controller sets the gap to achieve a desired tension on the buffer tube and receives a measurement of the tension on the buffer tube as the buffer tube passes between the first drive belt and the second drive belt. The controller determines whether the measurement of the tension on the buffer tube is within an acceptable range, and the controller commands a decrease in the gap between the first drive belt and the second drive belt in increments while the buffer tube passes between the drive belts until the tension is within the acceptable range.

According to still another aspect, embodiments of the disclosure relate to a non-transitory, machine readable storage medium for a controller of a buffer tube processing line. The storage medium includes program instructions configured, when executed on a processor, to carry out a method. The method involves setting a speed of and a gap between drive belts of a compression caterpillar to achieve a desired tension on a buffer tube. Tension on the buffer tube is measured as the buffer tube passes between the drive belts. It is determined whether the tension measured on the buffer tube is within an acceptable range, and the gap between the drive belts is decreased in increments while the buffer tube passes between the drive belts until the tension is within the acceptable range.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a cross-sectional view of a subunit, according to an exemplary embodiment;

FIG. 2 depicts a schematic representation of a processing line for producing a buffer tube, according to an exemplary embodiment;

FIG. 3 depicts a schematic representation of a compression caterpillar of the processing line, according to an exemplary embodiment;

FIG. 4 depicts a process flow diagram for controlling a tension applied to a buffer tube by drive belts of the compression caterpillar, according to an exemplary embodiment; and

FIG. 5 depicts an alignment guide for avoiding lateral drift of the buffer tube passing through the compression caterpillar, according to an exemplary embodiment.

### DETAILED DESCRIPTION

Referring generally to the figures, various embodiments of method and system for providing consistent tension on a buffer tube by a compression caterpillar on a processing line are provided. The consistent tension is controlled by automatically adjusting a gap between drive belts of the compression caterpillar based on measurements of the buffer tube tension. In this way, a subunit can be produced with an acceptable amount of excess fiber length without significant manual effort being necessary to maintain/replace the drive belts. Exemplary embodiments of the method and system will be described in greater detail below and in relation to the figures provided herewith, and these exemplary embodiments are provided by way of illustration, and not by way of limitation.

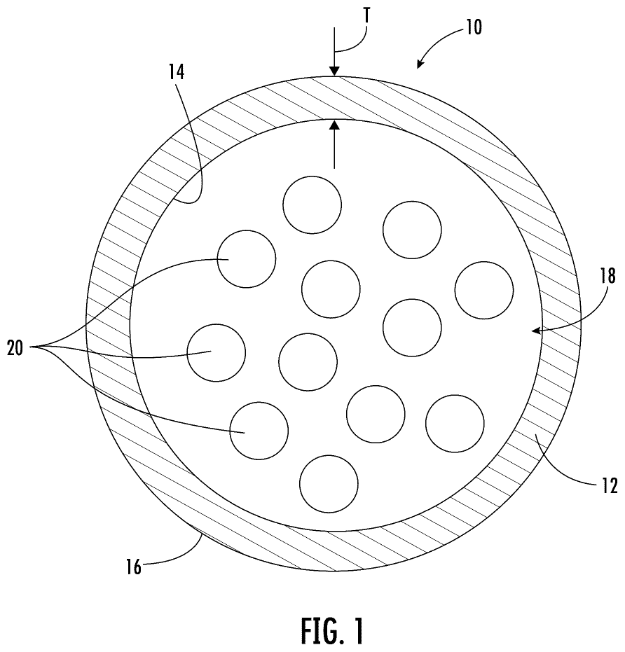

FIG. 1 depicts a cross-sectional view of an embodiment of a subunit 10. The cross-section is taken perpendicular to a longitudinal axis of the subunit 10, which extends along a length of the subunit 10. The subunit 10 includes a buffer tube 12 having an inner surface 14 and an outer surface 16. The inner surface 14 defines a central bore 18 of the subunit 10 that extends along the longitudinal axis. Disposed within the central bore 18 are a plurality of optical fibers 20. In one or more embodiments, the number of optical fibers 20 within the central bore 18 is from two to thirty-six optical fibers 20. In one or more embodiments, the number of optical fibers 20 within the central bore 18 is an integer multiple of twelve. In one or more embodiments, the subunit 10 also includes a water-blocking element (not pictured) in the central bore 18 of the buffer tube 12. Such water-blocking element can be, e.g., superabsorbent polymer powder or water-blocking gel.

The inner surface 14 of the buffer tube 12 defines an inner diameter of the buffer tube 12. In one or more embodiments, the inner diameter of the buffer tube 12 is from 1.5 mm to 1.9 mm. The outer surface 16 of the buffer tube 12 defines an outer diameter of the buffer tube 12. In one or more embodiments, the outer diameter of the buffer tube 12 is from 2.4 mm to 2.6 mm. The buffer tube 12 has a wall thickness T between the inner surface 14 and the outer surface 16. In one or more embodiments, the wall thickness T is from 0.3 mm to 0.5 mm. These buffer tube dimensions are merely exemplary, and other buffer tube sizes can be used. In particular, the method and system disclosed herein can be used with a variety of buffer tube designs so long as there is sufficient free space within the central bore 18 of the buffer tube 12 (so as to prevent coupling between the buffer tube 12 the optical fibers 20 during processing).

As will be discussed further below, the buffer tube 12 is made from one or more polymer materials. For example, the buffer tube 12 may be made from a single polymeric material, a blend of polymeric materials, or two or more layers of polymeric material. In one or more embodiments, the buffer tubes 12 are comprised of at least one polymer selected from, e.g., polyethylene (PE), polypropylene (PP), copolymers of PE and PP, polyamides (PA), polybutylene terephthalate (PBT), and polycarbonate (PC), among others. For example, the buffer tube 12 may include a composite structure of a layer of PBT around a layer of PC.

One or more subunits 10 as described may be incorporated into an optical fiber cable. In such a cable, the subunit 10 or subunits 10 may be surrounded by a cable jacket. In this way, the optical fiber cable may contain tens, hundreds, or even thousands of optical fibers 20 within a cable.

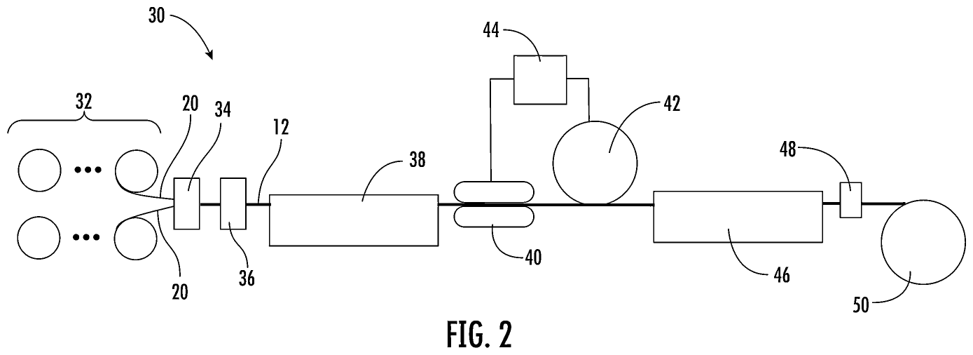

FIG. 2 depicts a processing line 30 for producing a subunit 10 as described. In particular, on the processing line 30, the buffer tube 12 is extruded around the optical fibers 20 to form the subunit 10. Because the processing line 30 is used to provide the buffer tube 12, the processing line 30 is also referred to as a “buffering line.” As can be seen in FIG. 2, the processing line 30 includes a plurality of payoffs 32 for the optical fibers 20. The processing line 30 includes a payoff 32 for each optical fiber 20 within the subunit 20. Thus, for example, a processing line 30 configured to produce a subunit 20 containing twelve optical fibers 20 would have twelve payoffs 32. The optical fibers 20 from the payoffs 32 are bundled and directed through an applicator 34, which applies a water-blocking material (such as super-absorbent polymer powder or water-blocking gel). After the applicator 34, the optical fibers 20 pass through an extruder 36 where one or more polymeric materials are extruded around the optical fibers 20 to form the buffer tube 12.

The molten polymeric material that forms the buffer tube 12 needs to be cooled, and thus, after the extruder 36, the buffer tube 12 and optical fibers 20 pass through a first water trough 38. The speeds at which the buffer tube 12 and optical fibers 20 move through the processing line 30 are determined by a compression caterpillar 40 and a capstan 42. A controller 44 controls the speeds at which the compression caterpillar 40 and the capstan 42 pull the buffer tube 12 and the optical fibers 12 as will be discussed below.

On the processing line 30, the compression caterpillar 40 is configured to push the buffer tube 12 at a rate faster than the capstan 42 pulls the optical fibers 20. For example, if the capstan 42 sets the line speed at a first speed, the compression caterpillar 40 may push the buffer tube 12 at a second speed that is from 1% to 10%, in particular about 5% faster than the first speed. For example, the capstan 42 may set a line speed of the processing line 30 of 800 meters/minute, and the compression caterpillar 40 may push the buffer tube 12 at a speed of 840 meters/minute. To accomplish this, the compression caterpillar 42 compresses the buffer tube 12 to a degree that it grips only the buffer tube 12 without also squeezing the optical fibers 20. In this way, the compression caterpillar 40 pushes excess buffer tube 12 onto the capstan 42. Once the buffer tube 12 cools down further, the buffer tube 12 will shrink, eliminating any excess buffer tube length as well as substantially preventing the creation of excess fiber length. That is, to account for shrinkage of the buffer tube 12 during cooling, the processing line 30 provides excess buffer tube 12 so that the buffer tube length will closely match (within +/−0.2%) the optical fiber length in the final subunit 10. The capstan 42 provides a locking point after which the buffer tube 12 and optical fibers 20 move at the same line speed.

As shown in FIG. 2, the processing line 30 includes a second water trough 46 downstream of the capstan 42. The second water trough 46 provides additional cooling of the buffer tube 12. After exiting the second water trough 46, the subunit 10 may pass through or by an air wipe 48 to remove the water from the subunit 10. Thereafter, the subunit 10 is taken up on a reel 50. FIG. 2 provides a generalized depiction of the processing line 30 for forming a subunit 10, including the elements necessary to explain operation of the disclosed system and method. In practice, though, the processing line 30 may include other components, e.g., affecting tension of the line downstream of the capstan 42, providing additional cooling, for bundling of the fibers going into the extruder 36, etc.

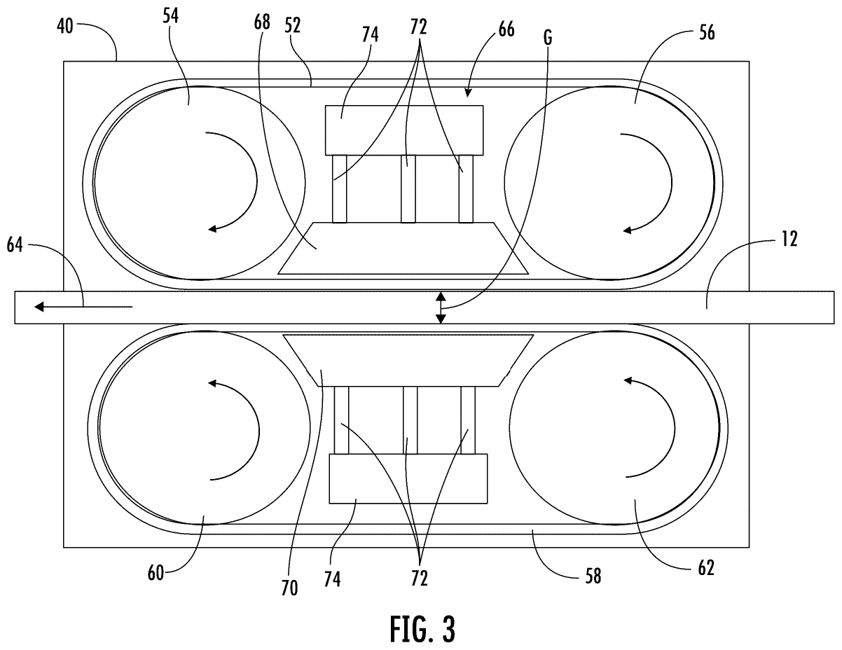

FIG. 3 depicts an embodiment of a compression caterpillar 40. The compression caterpillar 40 includes a first drive belt 52 driven by first head pulley 54 and a first tail pulley 56. The compression caterpillar 40 further includes a second drive belt 58 driven by a second head pulley 60 and a second tail pulley 62. The first head pulley 54 and the first tail pulley 56 rotate in a first direction (clockwise in the embodiment shown in FIG. 3) to drive the first drive belt 52, and the second head pulley 60 and the second tail pulley 62 rotate in a second direction (counterclockwise in the embodiment shown in FIG. 3) to drive the second drive belt 58. In this way, the first drive belt 52 and the second drive belt 58 counterrotate to push a buffer tube 12 entering between the tail pulleys 56, 62 in a line direction 64. In order to facilitate contact between the drive belts 52, 58 and the buffer tube 12, the compression caterpillar 40 includes an air saddle 66.

The air saddle 66 includes a first air hood 68 disposed between the first head pulley 54 and the first tail pulley 56 and a second air hood 70 disposed between the second head pulley 60 and the second tail pulley 62. The air hoods 68, 70 are arranged such that both of the drive belts 52, 58 pass between the air hoods 68, 70. The air hoods 68, 70 are each supplied with air by a plurality of air lines 72 connected to an air supply 74. In operation, the air supply 74 provides compressed air through the air lines 72 to the respective air hoods 68, 70. The air hoods 68, 70 distribute the pressurized air over the length of the air hoods 68, 70, providing pressure against the respective drive belts 52, 58. In this way, the drive belts 52, 58 remain in contact with the buffer tube 12 in the region between the tail pulleys 56, 62 and the head pulleys 54, 60.

The compression caterpillar 40 applies tension on the buffer tube 12 based primarily on two factors, namely the drive speed and the friction between the drive belts 52, 58 and the buffer tube 12. The friction is controlled by adjusting the gap G between the drive belts 52, 58 and by adjusting the pressure supplied by the air saddle 66. Decreasing the gap G increases the friction, and increasing the air saddle 66 pressure also increases the friction. Further, for air supplied at a given pressure, one way to control the pressure of the air saddle 66 is to adjust the distance between the air hoods 68, 70 and the respective drive belts 52, 58.

Conventionally, the tension provided by the compression caterpillar was set by empirical observation. That is, the gap and line speed were tested and checked for producing an excess fiber length (EFL) within an acceptable range. The processing line was set according to the observed conditions, and the processing line was run until the EFL was outside the desired range. Then, the gap between the drive belts was reduced (e.g., by 0.1 mm), which typically put the EFL back in the desired range. This gap would be adjusted in this way three times, and then the drive belts would have to be replaced because of wear. Thus, the conventional method required significant maintenance, and the line was run until failure, which means some of the subunits produced would have to be scrapped.

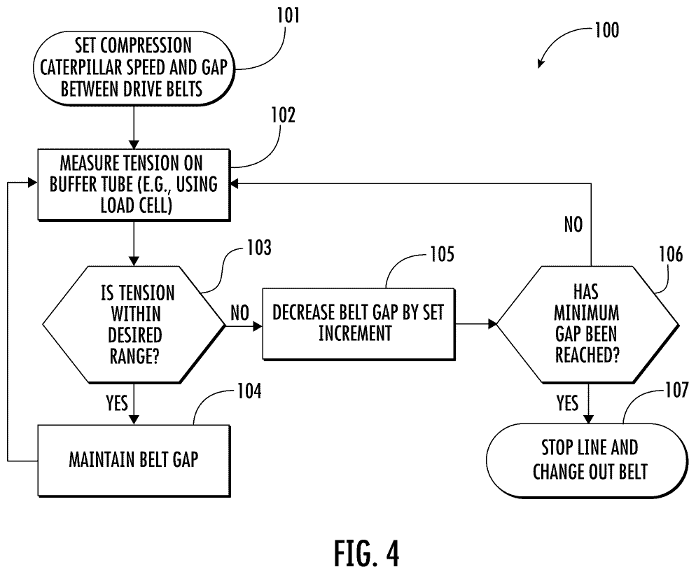

Maintaining all other process variables constant, the tension applied to the buffer tubes 12 by the compression caterpillar 40 correlates with EFL. Thus, according to embodiments of the present disclosure, the controller 44 monitors the tension that the compression caterpillar 40 applies to the buffer tube 12 and adjusts the gap G to maintain the tension within a set range. FIG. 4 depicts a method 100 carried out by the controller 44 for managing the tension in the compression caterpillar 40 to produce the desired EFL. In one or more embodiments, the desired EFL is less than 0.2%, and in particular 0.12% +/−0.06%. The final EFL relative to the buffer tube 12 may be different in the optical fiber cable because the final EFL will also be affected by later processing, such as stranding of the subunits 10 and extruding the cable jacket around the subunits 10. In one or more embodiments, the desired EFL discussed herein refers to the EFL for the stage of the process of producing the subunit 10 and does not relate to the EFL in the finally produced optical fiber cable.

In a first step 101 of the method, the processing line 30 is configured such that the speed and gap G between the drive belts 52, 58 is set to achieve the desired tension (e.g., 10 N to 50 N, in particular 13 N to 35 N) on the buffer tube 12. As discussed above, the initial operating parameters for the processing line 30 may be determined from empirical observation based on acceptable EFL in the final subunit 10. For example, in one or more embodiments, the initial speed of the compression caterpillar 40 may be 1% to 10%, in particular about 5%, greater than the speed of the capstan 42. Further, in one or more embodiments, the initial gap G between the drive belts 52, 58 may be set at the same diameter as the buffer tube. As mentioned above, the tension on the buffer tube 12 is determined, in part, by the air saddle 66. In one or more embodiments, a spacing between the air hoods 68, 70 and their respective drive belts 52, 58 is set to 0.6 mm. In one or more embodiments, an alignment jig may be used to set the spacing between the air hoods 68, 70 while the drive belts 52, 58 are off of the compression caterpillar 40 such that, when the drive belts 52, 58 are returned to the compression caterpillar 40, the desired spacing between the air hoods 68, 70 and their respective drive belts 52, 58 (e.g., 0.6 mm) is achieved.

Thereafter, in a second step 102, the tension on the buffer tube 12 is measured, e.g., continuously or in intervals. In one or more embodiments, the tension is measured, and a running average of the tension is calculated. In one or more embodiments, the compression caterpillar 40 includes a load cell for measuring the tension applied to the buffer tube 12. In one or more embodiments, the compression caterpillar 40 is fixed on the processing line 30 using a bearing, and the force exerted by the buffer tube 12 at the drive belts 52, 58 is proportional to the force on the bearing, which is measured by the load cell. In a third step 103, it is determined whether the tension is within a desired range for acceptable EFL. In one or more embodiments, the desired range is +/−3% of the initial tension set point. In one or more embodiments, the range is +/−1 N, in particular +/−0.5 N, and most particularly +/−0.35 N. If the measured tension is within the desired range, then the gap G between the drive belts 52, 58 is maintained according to step 104, and the method 100 returns to step 102 of measuring the tension on the buffer tube 12.

However, if the tension is not within the desired range, then according to a fifth step 105 the gap G between the drive belts 52, 58 is decreased. In general, the tension on the buffer tube 12 decreases over time because of abrasion and smoothing of the drive belts 52, 58 as the drive belts 52, 58 push the buffer tube 12, which reduces the friction between the buffer tube 12 and the drive belts 52, 58. Thus, the gap G between the drive belts 52, 58 is decreased to increase the friction between the buffer tube 12 and the drive belts 52, 58. In one or more embodiments, the gap G between the drive belts 52, 58 is decreased in increments of 0.005 mm to 0.05 mm, in particular 0.007 mm to 0.02 mm, and particularly about 0.01 mm. In one or more embodiments, the gap G is adjusted at a first rate during an initial portion of a run until the desired tension is achieved. Thereafter, in one or more embodiments, the gap G is adjusted at a second rate for the remainder of the run. In one or more embodiments, the first rate is greater than the second rate. In one or more embodiments, the first portion is shorter than the remainder of the run. For example, the gap G may be adjusted as needed every second during a first minute of the run, and thereafter, the gap may be adjusted every two seconds until the end of the run. In one or more embodiments, adjusting the gap G between the drive belts 52, 58 also adjusts the air saddle 66 to maintain the desired spacing between the air hoods 68, 70 and the respective drive belts 52, 58.

If the gap G between the drive belts 52, 58 is too small, then the buffer tube 12 may become undesirably ovular. In one or more embodiments, the minimum belt gap G is about half the diameter of the tube. As shown in a sixth step 106, it is determined whether a minimum gap G between the drive belts 52, 58 (or a maximum adjustment of the gap G) has been achieved. If not, then the tension is measured again according to step 102, and the method 100 proceeds from there. However, if the minimum gap G (or maximum adjustment of the gap G) has been achieved, then the processing line 30 is stopped according to a seventh step 107 so that the drive belts 52, 58 can be changed. After the drive belts 52, 58 are changed out, the method 100 is restarted using the new drive belts 52, 58.

According to embodiments of the present disclosure, the method 100 may be carried out by the controller 44 that is configured to run a program with instructions for carrying out the method stored on a non-transitory, machine-readable storage medium. Stated differently, the controller 44 can be configured with instructions that, when executed, cause the controller 44 to perform the method 100. The structure of the controller 44 is not particularly limited and can be any of a variety of structures known in the art for receiving sensor data and carrying out programmed instructions to cause the compression caterpillar 40 to adjust a gap between the drive belts 52, 58. In one or more embodiments, the controller 44 is a microcontroller (MCU) or a system on a chip (SoC). In one or more embodiments, the controller 44 includes a processor, such as a microprocessor, and memory, such as a system memory and a program memory, in which the processor is configured to carry out program instructions stored in the memory. In one or more embodiments, the memory is any non-transitory, machine readable storage medium. In one or more embodiments, the controller 44 is a field programmable gate array (FPGA) or an application specific integrated circuit (ASIC), among other possibilities. Further, in one or more embodiments, the controller 44 may be provided with a display output for an operator to visually monitor the operation of the processing line 30. Further, in one or more embodiments, the controller 44 may have a user input interface (e.g., a keyboard, a touchscreen, a voice command interface, a gesture-based command interface) to allow a user to set the initial operating parameters of the processing line 30. In some embodiments, the controller 44 may have a network interface by way of which the controller 44 can receive the initial operating parameters of the processing line 30 from another controller or computing device.

In some embodiments, the controller 44 can be configured to output an indication that a threshold gap G that is greater than the minimum gap G has been reached. In some embodiments, the threshold gap G can be a set minimum gap level plus 0.1 mm, the set minimum gap level plus 0.05 mm, the set minimum gap level plus 0.025 mm, or the set minimum gap level plus 0.02 mm. Responsive to the controller 44 determining that the threshold gap G has been reached, the controller 44 can output the indication that the threshold gap G has been reached. In various embodiments, the controller 44 can output the indication that the threshold gap G has been reached by controlling operation of an indicator light (e.g., turning on the light when the threshold gap G has been reached), outputting an indicator on a display (e.g., an LCD display or other display), causing a speaker to emit a sound, or the like. In some embodiments, the controller 44 can be configured to prevent a manufacturing line (e.g., the processing line 30) from being restarted after the threshold gap G has been reached notwithstanding that the minimum gap level has not yet been reached. The controller 44 can be configured to prevent the manufacturing line from being restarted until a reset condition is satisfied. For example, the controller 44 can prevent the manufacturing line from being restarted until an operator of the manufacturing line provides an authorization input to the controller 44 (e.g., by way of a user input interface).

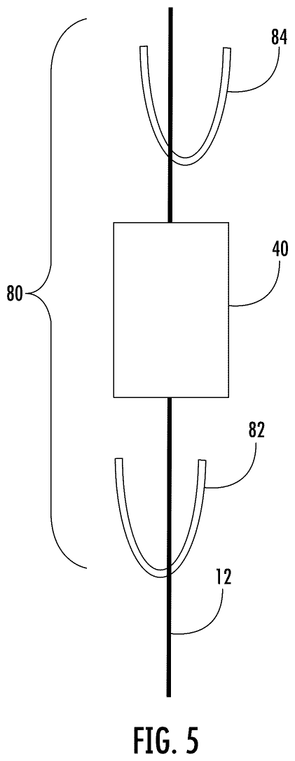

Applicants have also found that maintaining proper alignment of the buffer tube 12 entering the compression caterpillar 40 has an effect on the performance of the processing line 30. In particular, if the buffer tube 12 is allowed to drift laterally between the drive belts 52, 58, then the drive belts 52, 58 wear unevenly, which affects the friction on the buffer tube 12 and therefore the tension applied to the buffer tube 12. In order to maintain better alignment of the buffer tube 12 between the drive belts 52, 58, Applicants have developed an alignment guide 80 as shown schematically in FIG. 5. The alignment guide 80 includes a first eyelet 82 and a second eyelet 84 disposed on opposite sides of the compression caterpillar 40. In particular, the first eyelet 82 is positioned on an inlet side of the compression caterpillar 40, and the second eyelet 84 id positioned on an outlet side of the compression caterpillar 40. In one or more embodiments, the eyelets 82, 84 are arched, having two arms connected by a curved member to form a U-shape. As shown in FIG. 5, the eyelets 82, 84 are laterally offset such that the arms do not align along the longitudinal axis defined by the buffer tube 12.

By using the offset eyelets 82, 84, the alignment guide 80 controls drift of the buffer tube 12 on the processing line without having to direct the buffer tube 12 through a narrow alignment piece, which could pinch or snag the buffer tube 12. Instead, the two offset eyelets 82, 84 control left and right drift at longitudinally different positions without introducing the possibility of pinching or snagging the buffer tube 12. In one or more embodiments, the eyelets 82, 84 are made from a ceramic material. In one or more embodiments, the eyelets 82, 84 are polished to provide smooth surface over which to pass. In one or more embodiments, the eyelets 82, 84 can be positioned on a same inlet side of the compression caterpillar 40, rather than on opposite sides as depicted in FIG. 5.

Using the method and system as shown and described, the compression caterpillar is able to provide consistent tension, and therefore consistent EFL, on the buffer tube throughout the life of the drive belts. This avoids the manual adjustments that needed to be made when the EFL exceeded the desired range, and because the method does not run to failure, scrap subunits can be substantially reduced or eliminated. Further, because the tension is controlled by adjustments made to the belt gap, the processing line can be run at the maximum linespeed.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A method of controlling tension on a buffer tube produced on a buffer tube processing line, the method comprising:
directing the buffer tube through a compression caterpillar;
setting a speed of and a gap between drive belts of the compression caterpillar to achieve a desired tension on the buffer tube;
measuring tension on the buffer tube as the buffer tube passes between the drive belts;
determining whether the tension measured on the buffer tube is within an acceptable range;
decreasing the gap between the drive belts in increments while the buffer tube passes between the drive belts until the tension is within the acceptable range;
determining whether a threshold gap between the drive belts has been reached; and
responsive to determining that the threshold gap has been reached, outputting an indication that the threshold gap has been reached.

2. The method of claim 1, wherein decreasing the gap between the drive belts further comprises:
determining whether a minimum gap between the drive belts has been achieved, wherein the minimum gap is less than the threshold gap; and
stopping the buffer tube processing line when the minimum gap is achieved such that the drive belts can be replaced.

3. The method of claim 1, wherein the acceptable range is +/−3% of the desired tension.

4. The method of claim 1, wherein the acceptable range is +/−1 N.

5. The method of claim 1, wherein the compression caterpillar further comprises an air saddle having a first hood and a second hood, wherein the drive belts are disposed between the first hood and the second hood, and wherein the method further comprises applying pressurized air to the drive belts through the first hood and the second hood.

6. The method of claim 1, wherein decreasing the gap further comprises decreasing the gap at a first rate during a first portion of the method and decreasing the gap at a second rate during a remainder of the method, wherein the first rate is greater than the second rate.

7. The method of claim 1, further comprising:
providing a plurality of optical fibers from a corresponding plurality of payoffs;
extruding the buffer tube around the plurality of optical fibers to form a subunit;
cooling the buffer tube in a water trough;
directing the buffer tube through the compression caterpillar such that the drive belts apply tension to the buffer tube without compressing the plurality of optical fibers; and
pulling the subunit with a capstan at a line speed of the buffer tube processing line.

8. The method of claim 7, wherein setting the speed of the drive belts further comprises setting the speed 1% to 10% greater than the line speed.

9. The method of claim 1, further comprising directing the buffer tube through an alignment guide to limit lateral drift of the buffer tube between the drive belts of the compression caterpillar, the alignment guide comprising a first eyelet and a second eyelet that is laterally offset from the first eyelet.

10. The method of claim 9, wherein the first eyelet is positioned on an inlet side of the compression caterpillar and the second eyelet is positioned on an outlet side of the compression caterpillar.

11. A system for controlling tension on a buffer tube produced on a processing line, the system comprising:
a compression caterpillar comprising a first drive belt and a second drive belt, the first drive belt and the second drive belt having a gap therebetween;
a controller configured to control the gap between the first drive belt and the second drive belt;
wherein the controller sets the gap to achieve a desired tension on the buffer tube;
wherein the controller receives a measurement of the tension on the buffer tube as the buffer tube passes between the first drive belt and the second drive belt;
wherein the controller determines whether the measurement of the tension on the buffer tube is within an acceptable range;
wherein the controller commands a decrease in the gap between the first drive belt and the second drive belt in increments while the buffer tube passes between the drive belts until the tension is within the acceptable range; and
wherein responsive to the controller determining that a threshold gap between the first drive belt and the second drive belt has been reached, the controller outputs an indication that the threshold gap has been reached.

12. The system of claim 11, wherein the controller determines whether a minimum gap between the drive belts has been achieved and commands the processing line is stopped when the minimum gap is achieved such that the drive belts can be replaced.

13. The system of claim 11, wherein the acceptable range is +/−3% of the desired tension.

14. The system of claim 11, wherein the compression caterpillar further comprises an air saddle having a first hood and a second hood, wherein the first drive belt and the second drive belt are disposed between the first hood and the second hood, and wherein the air saddle is configured to apply pressurized air to the first drive belt and the second drive belt through the first hood and the second hood, respectively.

15. The system of claim 14, wherein the first hood is spaced a set distance from the first drive belt and the second hood is spaced the set distance from the second drive belt.

16. The system of claim 11, wherein the controller decreases the gap at a first rate during a first portion of a run and decreases the gap at a second rate during a remainder of the run, wherein the second rate is less than the first rate.

17. The system of claim 11, wherein the processing line further comprises a capstan that sets a line speed of the processing line and wherein the compression caterpillar is configured to push the buffer tube at a speed that is 1% to 10% greater than the line speed using the first drive belt and the second drive belt.

18. The system of claim 11, wherein the compression caterpillar further comprises an alignment guide comprising offset eyelets, wherein the alignment guide is configured to limit lateral drift of the buffer tube between the drive belts of the compression caterpillar.

19. A non-transitory, machine readable storage medium for a controller of a buffer tube processing line, the storage medium comprising program instructions that, when executed by a processor, cause the processor to carry out a method comprising:
setting a speed of and a gap between drive belts of a compression caterpillar to achieve a desired tension on a buffer tube;
measuring tension on the buffer tube as the buffer tube passes between the drive belts;
determining whether the tension measured on the buffer tube is within an acceptable range;
decreasing the gap between the drive belts in increments while the buffer tube passes between the drive belts until the tension is within the acceptable range; and
responsive to determining that the gap between the drive belts has reached a threshold, outputting an indication that the threshold has been reached.

20. The storage medium of claim 19, wherein the method further comprises:
determining whether a minimum gap between the drive belts has been achieved; and
stopping the buffer tube processing line when the minimum gap is achieved such that the drive belts can be replaced.
